(19) United States
(12) Patent Application Publication
(10) Pub. No.: US 2012/0059931 A1
(43) Pub. Date: Mar. 8, 2012

(54) SYSTEM AND METHODS FOR A REPUTATION SERVICE

(76) Inventors: Sven Graupner, Mountain View, CA (US); Christopher Peltz, Windsor, CO (US); Julio Guijarro, Bristol (GB); Edward S. Reynolds, Plano, TX (US); Michael K. Smith, Austin, TX (US)

(21) Appl. No.: 12/877,507

(22) Filed: Sep. 8, 2010

(51) Int. Cl. G06F 15/173

(52) U.S. Cl. 709/224

(57) ABSTRACT

A system comprises a processor and storage containing software. When executed, the software causes the processor to receive a set of metrics to be monitored, cause to be monitored the set of metrics, and filter the monitored metrics per a sharing policy to produce a subset of the set of metrics.

### BACKGROUND

A multitude of services are available to consumers. Such services may include telephone services, power services, email services, and the like. And multiple choices of services providers exist for each category of services. It is difficult, however, for consumers to know which service provider is better than another within a given service category.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 shows a computer usable in the system of FIG. 1 in accordance with various embodiments;

FIG. 3 illustrates interactions between service providers, service consumers, and a reputation service in accordance with various embodiments; and

FIG. 4 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

The term “service consumer” is used herein. A service consumer may refer to one or more human beings that use one or more services. While a service consumer literally may be a human being, the term “service consumer” is generally used herein to refer to the computer system owned, operated, and/or used by such human beings as they use various services.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

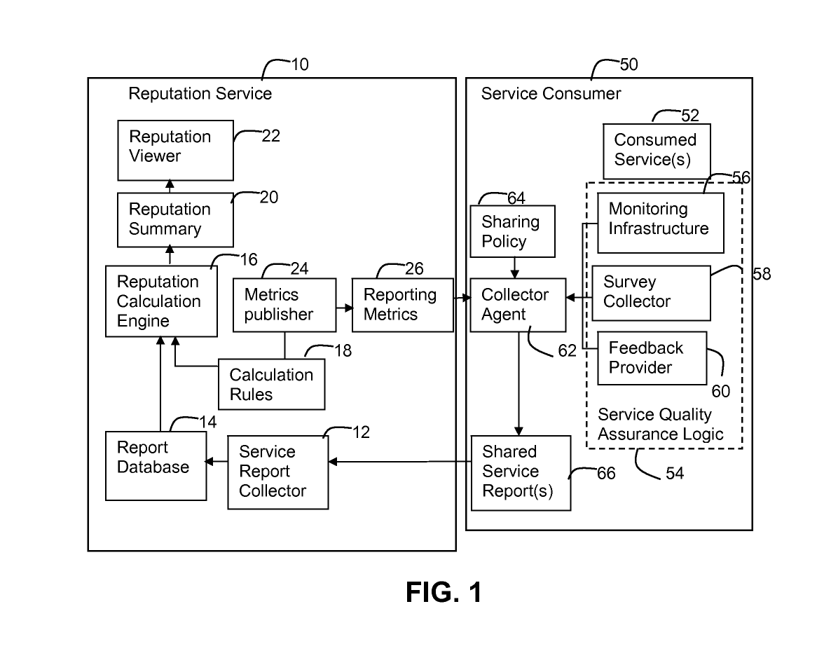

FIG. 1 shows a system in accordance with various embodiments. The system includes a reputation service 10 and one or more service consumers 50. In general, the service consumers monitor the performance of the services they use and provide service reports to the reputation service 10 which generates summaries of the service reports. Each service consumer generates its own service report. The reputation service 10 may also compute an overall score for each of the various services. In accordance with various embodiments, each service consumer 50 subscribes to (registers with) the reputation service 10 to inform the reputation service that the subscribed service consumer 50 wants to monitor its consumed services under the control of the reputation service and receive report summaries from the reputation service 10 to inform users of the service consumer 50 as to how well the services it uses compare to other services in the same category. The subscription process entails, for example, the service providing its connectivity information (e.g., Internet Protocol (IP) address, email address, etc.) to the reputation service 10, demographic information such as contact name, address and telephone number, and a list of the types of services used by the service consumer.

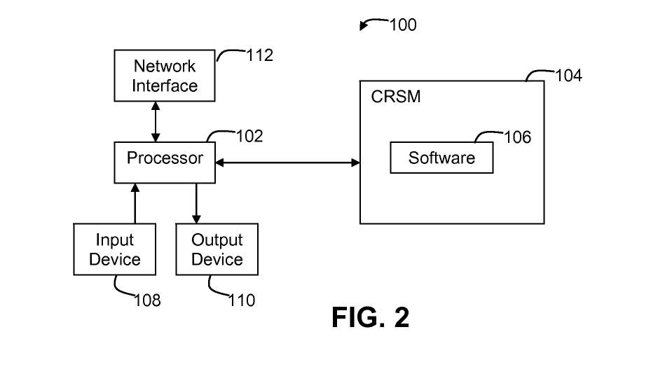

In various embodiments, the reputation service 10 is implemented as software that executes on one or more processors of one or more computers. FIG. 2 illustrates an embodiment of a computer 100 that is suitable for hosting the reputation service 10. As shown in FIG. 2, the computer 100 includes one or more processors 102 coupled to a computer-readable storage medium (CRSM) 104, an input device 108, an output device 110, and a network interface 112. The CRSM 104 may comprise volatile memory such as random access memory, non-volatile storage (e.g., hard disk drive, compact disc read only memory, flash storage, read only memory, etc.), or combinations thereof. The CRSM 104 contains software 106 that is executed by the processor(s) 102 to implement some or all of the functionality described herein as attributed to the reputation service 10. The input device 108 may comprise a keyboard, mouse, or other types of input or pointing devices. The output device 110 may comprise a display. The network interface 112 comprises, for example, a network interface controller (N IC) through which the reputation service 10 has connectivity to other computers and services on local or wide area networks.

Referring again to FIG. 1, the reputation service 10 exchanges information with a service consumer 50 via, for example, the network interface 112 noted above. The service consumer 50 uses or otherwise consumes one or more services such as services 52 which are provided by service providers. Such services 52 may include services from a wide variety of service categories such as power services, email services, internet services, and the like.

The service consumer 50 may include a variety of hardware and software for consuming the services 52. FIG. 1, however, shows the functional elements of the service consumer 50 that are relevant to the needs of the reputation service 10 for monitoring and reporting performance metrics. Such functional elements of the service consumer 50 may be implemented on one or more computers having an architecture similar to that of computer 100 of FIG. 2 which was described above. Thus, some or all of the functionality described herein as attributed to the functional elements of the service consumer 50 are performed by one or more processors (e.g., processor(s) 102) while executing software (e.g., software 106). In some embodiments, the reputation service 10 is hosted on one computer and the service consumer 50 is hosted on a different computer and the computers are linked together via a network. In some embodiments the reputation service 10 is owned and operated by the service consumer 50, while in other embodiments, one party owns and operates the reputation service 10 while the service consumer 50 is of a different party. The underlying consumed services 52 are provided by yet a different party still from the reputation service 10 and service consumer 50 in various embodiments. Thus, in some embodiments three different parties may own, operate and/or provide the reputation service 10, the service consumer 50, and the consumed service 52, while in yet other embodiments, the same party owns, operates, and/or provides both the reputation service 10 and one or more of the service consumers 50.

Referring still to FIG. 1 and as noted above, the service consumer 50 uses a service 52 (e.g., technical help service, emails service, internet service, etc.). The service consumer 50 includes service quality assurance logic 54 which monitors the performance of the consumed service 52. One or more metrics are monitored for the service 52. The various metrics to be monitored depends on the type of service 52 being consumed by the service consumer 50. Take the example of a technical help service category. Illustrative metrics for a technical help service might include availability (i.e., the percentage of time the help service is up, running and available), resolution rate (i.e., percentage of the consumers requesting technical help that result in a satisfactory resolution), average resolution time (the average amount of time required to resolve the problems, and the support quality (a consumer rating of the quality of the technical help staff measured, for example, a on a scale of 1 to 5). Different types of metrics are suitable for different types of service categories.

The service quality assurance logic 54 may include an automated monitoring infrastructure 56, survey collection 58, and feedback providers 60. The automated monitoring infrastructure 56 may include software agents embedded in and around the service 52. Each such agent monitors one more specific metrics and does so without human involvement. Some such agents may be programmable in terms of the sort of metrics they are to monitor. Personnel may also complete survey forms periodically and submit such survey responses on-line via the survey collector 58. The feedback provider 60 comprises a component that allows users to provide feedback about their experiences with a service provider in an ad hoc manner. Via the feedback provider 60, a user can, for example, lodge complaint such as in a free-form text field on web page.

The collector agent 62 collects all such monitored/feedback information and generates one or more shared service reports 66 which contain monitored/feedback information and which are transmitted to the service report collector 12 of the reputation service 10. Such service reports may be requested by the reputation service 10 or may be automatically provided at predetermined intervals by the collector agent 62.

The service report collector 12 retrieves service reports from one, multiple, or all service consumers 50 that subscribe to the reputation service 10. The collected service reports are then stored in a report database 14.

From the database 14, reputation service 10 retrieves one or more of the service reports and, if desired, processes the reports through a reputation calculation engine 16. The reputation calculation engine 16 applies one or more calculation rules 18 to compute a score for each service provider based on the contents of the service reports provided by the various service consumers 50. In some embodiments, the computed score is a weighted average of the various reported metrics and the calculation rules 16 specifies that a weighted average is to be computed and the applicable weights. Numerous other mathematical algorithms for computing a score can be applied as well. An overall score can be, but need not be, computed.

The reputation service 10 also generates a reputation summary 20 for each service category. For the example of a technical help service, the following table represents an illustrative reputation summary.

| | | | Average | |
|---|---|---|---|---|
| Service | | Resolution | Resolution | Support |
| Provider | Availability | Rate | Time | Quality |
| SP 1 | 99.945% | 82% | 16.2 h | **** |
| SP 2 | 98.875% | 80% | 18.2 h | ** |
| SP 3 | 98.465% | 74% | 14.2 h | *** |
| SP 4 | 92.374% | 58% | 24.2 h | * |

(Reported by 3,483 Service Desk customers for SP 1; 4,466 for SP 2; 2,569 for SP 3; and 574 for SP 4.)

In the above example, there are four service providers of technical help services, SP1-4. For each service provider, four metrics are provided—availability, resolution rate, average resolution time, and support quality. As can be seen SP1 was deemed to be available 99.945% of the time, had a resolution rate of 82%, had an average resolution time of 16.2 hours, and service consumers rated SP 1 on average as four stars. By contrast, SP4 was available only 92.374% of the time, had a resolution rate of only 58%, had an average resolution time of 24.2 hours, and was rated on average as only a single star by its consumers. The reputation viewer 22 includes a graphical or textual interface to permit a user to view the summarized results.

Although not shown in the table above, an overall score could be calculated as well for each service provider and provided to the reputation viewer 22. In one example, the reputation calculation engine 16 computes a weighted average of the various metrics to calculate a numerical overall score. A metric that is considered more important may be assigned a higher weight. A user (e.g., a person, a department, an organization, etc.) of the reputation service 10 specifies the calculation rule (e.g., average) to be applied as well as the weights via a graphical user interface implemented by software 106.

Based on such summaries, service consumers can compare how the service providers whose services they use compare to other service providers of similar services. Further still, a consumer in the market to purchase a service in a particular category can consult such summaries when deciding which service to purchase. It might be that a consumer would want the highest quality service (SP1 in the example above), or might be tolerant of lesser quality service given the price.

Referring still to FIG. 1, the reputation service 10 determines the metrics that should be monitored by the service consumers 50 for a given service category. In the example above, the metrics deemed relevant for the technical help service include availability, resolution rate, average resolution time, and support quality. For a different service category, a different set of metrics may be deemed relevant. The metrics publisher 24 of the reputation service 10 provides a graphical user interface, or other input mechanism, to a user of the reputation service 10 to enable the user to specify which metrics are relevant for a given service category. The set of relevant metrics is provided to the service consumer 50 as reporting metrics 26.

The collector agent 62 receives the set of reporting metrics 26 from the reputation service 10 and applies a sharing policy 64 to filter the monitored/feedback information from the service quality assurance logic 54. Each service consumer 50 may have its own sharing policy 64 which may be configurable by a graphical user interface accessible to a user of the service consumer 50. The sharing policy 64 for a given service consumer 50 may define those metrics that that particular service consumer 50 may report back to the reputation service 10. Any metric not listed in such a sharing policy 64 is not permitted to be reported back to the reputation service 10. For example, if the reporting metrics 26 include the four metrics availability, resolution rate, average resolution time, and support quality, but only the three metrics availability, average resolution time, and support quality are included in a service consumer's sharing policy 64, then the fourth metric (resolution rate) may be monitored by the service consumer 50 but not included in the shared service report 66 and thus not reported back to the reputation service 10 by that particular service consumer 50. In other embodiments, the sharing policy 64 may list those metrics that are not permitted to be provided to the reputation service 10, and thus any metric not listed in the sharing policy 64 can be included in the shared service report 66. The sharing policies 64 permit the service consumers 50 some degree of control over what metric information is provided to the reputation service 10. The collector agent 62 for a given service consumer 50 compares the metrics being monitored by the service quality assurance logic 54 to the sharing policy and thereby produces a subset of the monitored metrics to be included in a service report 66. The collector agent 62 of each service consumer 50 operates in a similar fashion. Each such service consumer thus produces its own service report 66 based on its own sharing policy 64.

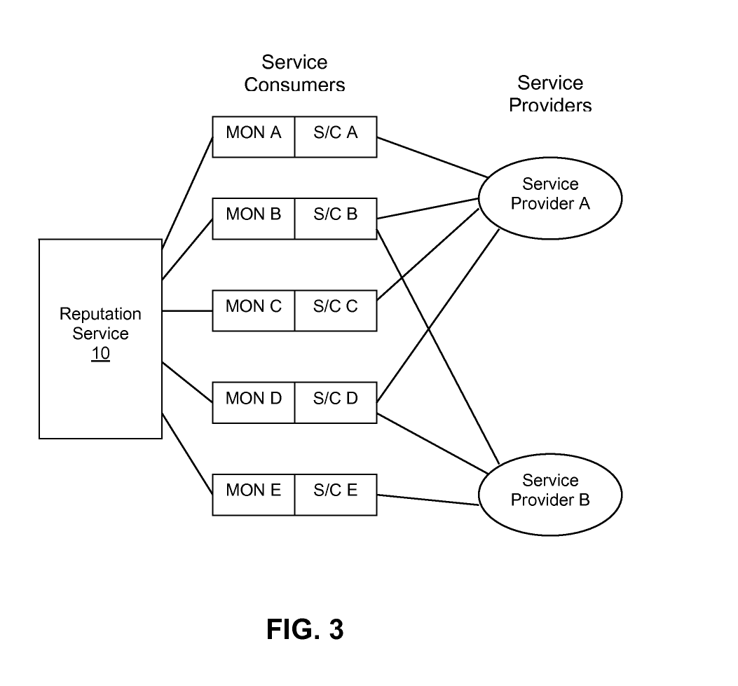

FIG. 3 provides an example of a reputation service 10 to which five service consumers (SC A-E) subscribe and provide metric information. Two service providers (Service Provider A and Service Provider B) are also shown. Service Provider A is used by Service Consumers A, B, C, and D, while Service Provider B is used by Service Consumers B, D, and E. Some service consumers use only one of the two service providers, and other service consumers use both service providers. Each service consumer has or otherwise is associated with monitoring logic that monitors the requested metrics and provides the requested metrics to the reputation service 10 as described above. Thus, Service Consumers A-E include Monitors A-E, respectively. The Monitors A-E include, for example, the service quality assurance logic 54 of FIG. 1.

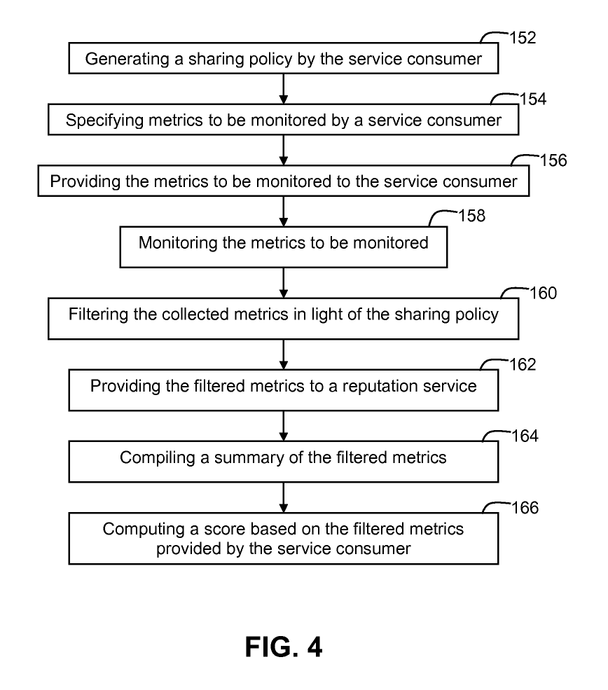

FIG. 4 shows a method in accordance with various embodiments. The various actions shown are performed by a processor (e.g., processor 102) executing software (e.g., software 106) of either of the reputation service 10 or service consumer 50. Some actions may be performed by the reputation service 10 while other actions may be performed by the service consumer 50. Further still, the actions may be performed in the order shown in FIG. 4, or in a different order. Also, two or more of the actions may be performed simultaneously.

Referring to FIG. 4, the method includes generating a sharing policy (e.g., sharing policy 64) by the service consumer 50. At 154, the method comprises specifying, by the reputation service 10, the metrics that are to be monitored by the service consumers in a particular service category (e.g., availability, resolution rate, etc. for the technical help service category). At 156, method comprises providing, by the reputation service, the metrics to be monitored to the service consumer 50.

At 158, the service consumer 50 monitors the service for the various metrics and, at 160, filters the collected metrics in light of the sharing policy. At 162, the service consumer 50 provides the filtered metrics to the reputation service 10 which at 164 compiles a summary of the filtered metrics. The reputation service 10 also may compute (166) an overall score of the filtered metrics as explained previously.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
specifying, by a first processor of a reputation service, metrics to be monitored by a service consumer;
providing, by the first processor of the reputation service, said metrics to be monitored to said service consumer;
monitoring, by a second processor of a service consumer, said metrics to be monitored;
filtering, by the second processor of the service consumer, said collected metrics in light of a sharing policy;
providing, by the second processor of the service consumer, said filtered metrics to a reputation service; and
compiling, by the first processor of the reputation service, a summary of the filtered metrics.

2. The method of claim 2 wherein said sharing policy is indicative of which metrics can be monitored by said service consumer and wherein filtering said collected metrics comprises comparing said metrics to be monitored provided by the first processor of the reputation service to the metrics that can be monitored as indicated by the sharing policy.

3. The method of claim 1 further comprising generating the sharing policy by the second processor of the service consumer.

4. The method of claim 1 wherein monitoring said metrics comprises collecting said metrics without human involvement.

5. The method of claim 1 wherein monitoring said metrics comprises collecting said metrics without human involvement and providing feedback information from a human.

6. The method of claim 1 further comprising computing, by the first processor of the reputation service, a score based on the filtered metrics provided by the second processor of the service consumer.

7. The method of claim 6 wherein the score is computed by computing at least one of an average of the filtered metrics and a weighted average of the filtered metrics.

8. The method of claim 1 wherein specifying, by the first processor of the reputation service, metrics to be monitored by a service consumer comprises specifying metrics to be monitored by a plurality of service consumers that each have a sharing policy.

9. A system, comprising:
a processor; and
storage containing software that, when executed by the processor, causes the processor to receive a set of metrics to be monitored, cause to be monitored said set of metrics, and filter said monitored metrics per a sharing policy to produce a subset of the set of metrics.

10. The system of claim 9 wherein said software causes the processor to provide a graphical user interface to enable a user to specify the metrics to be included in the sharing policy.

11. The system of claim 9 wherein said software causes the processor to filter the monitored metrics by comparing the sharing policy to the set of metrics to be monitored.

12. The system of claim 9 wherein the software causes the processor to generate a service report including the subset of the set of metrics.

13. A computer-readable storage medium (CRSM) containing software that, when executed by a processor, causes the processor to:
generate a set of metrics to be monitored by service consumers;
provide said set of metrics to the service consumers;
receive a service report from each service consumer, each service report containing metrics that have been monitored by each respective service consumer; and
generate a summary of the service reports.

14. The CRSM of claim 13 wherein the software further causes the processor to compute a score based on the metrics from each service report.

15. The CRSM of claim 14 wherein the score is a weighted average.
